(19) United States
(12) Patent Application Publication
(10) Pub. No.: US 2009/0241615 A1
(43) Pub. Date: Oct. 1, 2009

(54) DEFEATABLE ROOM ACCESS CONTROL SYSTEM AND METHOD

(76) Inventor: John Christopher Hansknecht, Williamsburg, VA (US)

Correspondence Address: John C. Hansknecht, 527 Lakeshead Drive, Williamsburg, VA, 23185, US

(21) Appl. No.: 12/055,271

(22) Filed: Mar. 25, 2008

(51) Int. Cl. E05B 63/08

(52) U.S. Cl. 70/224

(57) ABSTRACT

A defeatable room access control system and method having: 1) an electronic mortise lockset limiting access to a protected room; 2) an authorized user detection scheme controlling the lockset; 3) a door interlock mechanism confirming the closure status of the door; 4) an ability to override the door interlock mechanism when an authorized user is detected. 5) one or more microprocessors programmed to monitor and control all functions.

### FIELD OF THE INVENTION

The present invention relates to access control of an interlocked entryway and, more particularly, the system and method used to control access and selectively defeat an interlocked entryway based on electronically monitored entry and exit actions.

### BACKGROUND OF THE INVENTION

There are applications that require controlled access through an entryway that is simultaneously being monitored by a safety interlock system. One such example is that of entering a room containing a high powered laser, hereinafter known as Laser Controlled Area or LCA. It is common for a Laser Controlled Area to have a potential for personnel exposure to blinding or burning laser energy, therefore entry to a LCA without proper training and precautions can be extremely hazardous. In such cases, it is advantageous to utilize engineered safety controls to grant access only to qualified individuals wearing specialized eye wear and, in some cases, personal protective clothing. Historically this type of engineered safety access control has utilized an electromagnetic lock to keep the door locked, and an interlock closure sensor to verify the door is closed. When a qualified individual produces the proper credentials for entry (i.e. key code, swipe card, biometric identification, etc.), the control system temporarily overrides (defeats) the interlock door closure sensor and releases the door lock. When the door is subsequently closed, the defeat is cancelled and the interlock door closure sensor is reactivated. If an access is attempted by an unqualified individual, the access control system is designed to deny access. If the magnetic lock is overcome through brute force or other means, the interlock door closure sensor will sense an entry violation and trip the safety interlock system. Once tripped, a safety shutter attached to the safety interlock will block all hazardous energy from the high power laser. In some cases, the laser itself will be shut down via a connection from the laser power supply to the safety interlock system.

It should be evident that a worker within the LCA must also follow a protocol to permit an exit from the area without tripping the safety interlock system. Historically this protocol has been the activation of an electrical switch or sensor from the interior of the room to “request” an exit. When the request is received by the engineered safety system, the system once again temporarily overrides (defeats) the interlock door closure sensor and releases the door lock for personnel exit.

The main feature of an access control system is the systems ability to electronically lock a door and selectively grant access. The magnetic lock has been reliably used in thousands of installations, but when considering other solutions that would offer an electronic control of a locked door, one might consider an electric door strike plate. The electric door strike mounts in the frame of the door in place of the normal strike plate. The strike plate is the piece engaged by the latch bolt of a mortise lockset mounted on the swinging door. The mortise lockset is normally locked and the control system can apply electric current to the strike plate to release it, permitting the door to swing free without turning the handle of the lockset to retract the latch bolt. It would appear that the electric door strike could be used in place of a magnetic lock, but there are numerous disadvantages that make it a poor choice for use in a LCA as detailed below.

Like the magnetic lock, the electric strike requires a hard wired connection to a control system. This can make installation difficult in a post construction situation, especially in situations where the door frame has been filled with cement or plaster. Electric strikes often require extensive modification to the door frame or strike dust box. This modification may void the UL fire rating of the door, a particular concern when considering installation in a room housing a high power laser. Furthermore, it is difficult to find an electric strike that will install in a double door where the wiring connection must flex when the door leaf with the strike is opened. Since most laser laboratories have double doors to permit the passage of large laser tables, the electric strike is not a welcomed solution. This is further evidenced by the fact that commercial laser safety system vendors rarely recommend the electric strike as an option. The magnetic lock has been the control mechanism of choice in this application for over thirty years.

Although it has been in use for decades, the magnetic lock is not an ideal solution as is evidenced by the following notable problems:

The first problem is that of the magnetic lock behavior. Although electrically fail-safe, the use of magnetic locks is often discouraged by Fire Marshals because of a fear of the potential to hold a door closed in an emergency, trapping a room occupant within the protected space. Some municipalities, hospitals, and educational facilities will not permit the installation of magnetic locks for this reason. To alleviate this fear, system engineers will usually provide emergency crash switches to directly break power to the magnetic lock should the control system fail to release the lock in a timely manner. Many municipalities and some governments also have strict laws that mandate the connection of the magnetic lock circuit to the building fire alarm system. Again, this connection will directly break power to the magnetic lock and cause it to immediately release.

The second problem is that of the mechanical complexity of magnetic lock installation. The mechanical installation of a magnetic lock can be challenging. There is not a “one size fits all” lock design that will work with every type of door. Special spacers, “L” brackets, and “Z” brackets are usually required to adapt the lock to a door frame. Furthermore, the armature plate must be in near perfect alignment with the magnetic lock for proper lock operation. Any “play” in the door when closed will create the possibility of a failure of the lock to engage.

The third problem is that of the complexity of electrical wiring associated with magnetic locks. The electrical wiring can be complex since the lock power source must pass through the emergency crash switch(s), building fire alarm contactor, and safety system controller.

The fourth problem is that of security during power failure. In the application of a laser controlled area, there is no laser hazard at this point because a properly designed interlock system will trip the lasers, but the magnetic lock releases the door upon loss of power. This leaves the LCA completely unlocked unless a secondary mortise lockset has been utilized and engaged in the locked position.

Accordingly, principal objects of the present invention are to overcome these problems as outlined above with a simple, safe, and effective solution.

### SUMMARY OF THE INVENTION

In accordance with the present invention, there is provided a defeatable room access control system utilizing an electronic mortise lockset. The system has the ability to override (defeat) a door interlock position sensor synchronously with the operation of the lockset. The electronic mortise lockset is mounted in place of a conventional lockset on the entry door to a protected area. By design, the electronic mortise lockset permits access from the outside of the protected room only to persons who have presented the proper credentials for entry. The interior handle of the electronic lockset does not rely on electronic control and is always operational for unrestricted exit from the secure area. In the preferred embodiment, the lockset is capable of wireless transmission of an override signal to a remotely mounted receiver when proper credentials are detected by the lockset. The receiver processes the signal and temporarily overrides a door interlock position sensor, thus permitting access into the protected area without tripping the interlock circuit. If the lockset is opened without proper credentials, either by force or by design, the lockset does not transmit the signal to override the door interlock position sensor and the interlock circuit trips when the door is opened, thereby dropping attached safety equipment to a safe mode. The preferred embodiment lockset also provides an automatic override of the door interlock position sensor when a person wishes to exit the protected area. This automatic override is accomplished using a proximity detection sensor that is capable of detecting a hand approaching the interior handle.

Accordingly, several objects and advantages of the present invention are:

(a) to provide a simple electronic mortise lockset in lieu of the electromagnetic locks presently used for access control to a protected area. The electronic lockset restricts entry, but functions identically to a conventional mortise lockset for exit from an area. This method of access control has a demonstrated acceptance by Fire Marshals and other concerned entities;

(b) the elimination of complications associated with the precise mechanical installation and alignment requirements of magnetic locks by using an electronic mortise lockset where mechanical installation is as simple as any conventional lockset;

(c) the simplification of wiring over that of a magnetic lock system through the elimination of auxiliary components that are required to make magnetic locks failsafe. (e.g. crash switches, fire alarm system connection, and magnetic lock controller);

(d) the enhanced security of the electronic mortise lockset over the complete lack of security of the magnetic lock during a power failure;

Other objects, features, and advantages of the invention will become apparent from a consideration of the following detailed description and from the accompanying drawings.

### BRIEF DESCRIPTION OF THE DRAWINGS

FIG. 1 is a perspective view of an electronic mortise lockset mechanism;

FIG. 2 is a perspective view of an electronic mortise lockset mechanism mounted on a door to a protected room;

FIG. 3 is a perspective view of an electronic mortise lockset mechanism with transmitter, and receiver mounted on interior door of protected room;

FIG. 4 is a perspective view of an example of the preferred embodiment of the electronic mortise lockset mechanism with transmitting and proximity detecting functions;

FIG. 5 is a perspective view of a preferred embodiment of the door interlock receiver module mounted on interior of protected room;

FIG. 6 is a perspective view of an alternate embodiment of the electronic mortise lockset with a conversion communication and proximity detection module;

FIG. 7 is a perspective view of an alternate embodiment of electronic mortise lockset with a hard-wired override of the monitored door;

FIG. 8 is a detail view of an electronic mortise lockset transmitter operational block diagram;

FIG. 9 is a detail view of an electronic mortise lockset transmitter microcontroller pseudo-code;

FIG. 10 is a detail view of an electronic mortise lockset transmitter schematic;

FIG. 11 is a detail view of a receiver module operational block diagram;

FIG. 12 is a detail view of a receiver module microcontroller pseudo-code; and

FIG. 13 is a detail view of a receiver module electronic schematic.

For purposes of clarity and brevity, like elements and components will bear the same designations and numbering throughout the Figures.

### DETAILED DESCRIPTION OF THE INVENTION

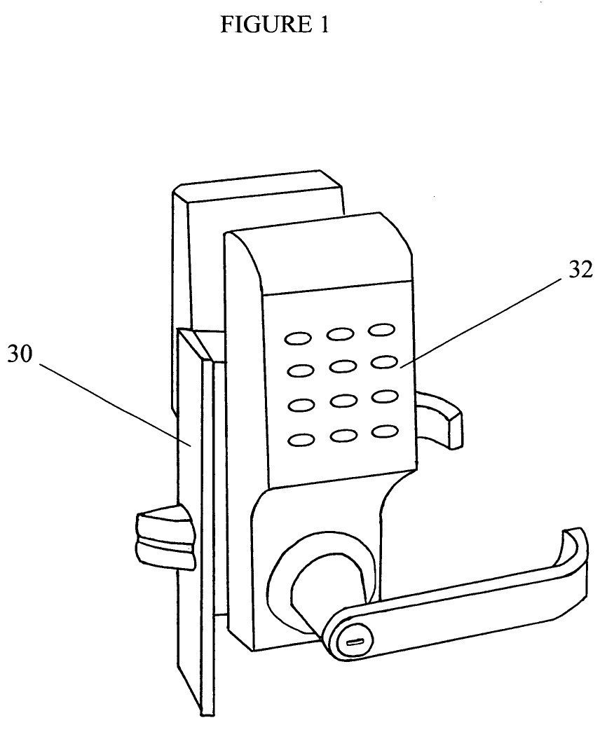

FIGS. 1-5—Preferred Embodiment

FIG. 1 is a perspective view of an electronic mortise lockset mechanism 30. Although it will be preferable to manufacture a new electronic mortise lockset with all operational enhancement features claimed, economics of scale presently dictates the modification of an existing commercial product to add the interlock control functions. The construction and operation of the electronic mortise lockset itself is dictated by the manufacturer of the product and as such is not detailed here, but the system and method of modifying the product to perform the desired interlock control functions is described in detail.

The electronic lockset of FIG. 1 utilizes a keypad as a means for confirming access credentials 32, but other versions of electronic mortise lockset can be easily modified to perform the interlock control functions. These versions include, but are not limited to, magnetic card access, biometric identification access, touch key access, and smart card access. An alternate embodiment can exist that utilizes an electronic mortise latch bolt with a remotely located electronic package designed to confirm access credentials as well as control interlock bypass and lockset command operations. This alternate embodiment's operation is not detailed here, but falls within the scope of the invention. The electronic mortise lockset used in the preferred embodiment is the Codelocks model 5210 manufactured by CODELOCKS, ltd., available from Codelocks LLC of Costa Mesa, Calif.

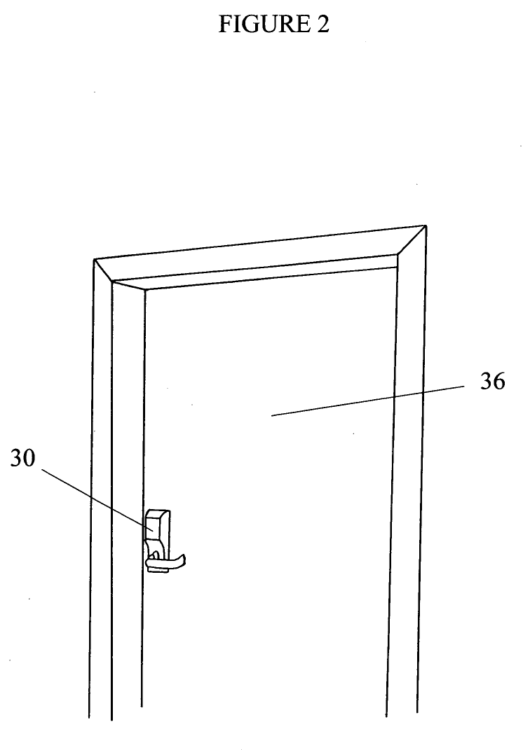

FIG. 2 is a perspective view of an electronic mortise lockset mechanism 30 mounted on a door to a secure area 36. The user must produce proper credentials to access the area without tripping the interlock.

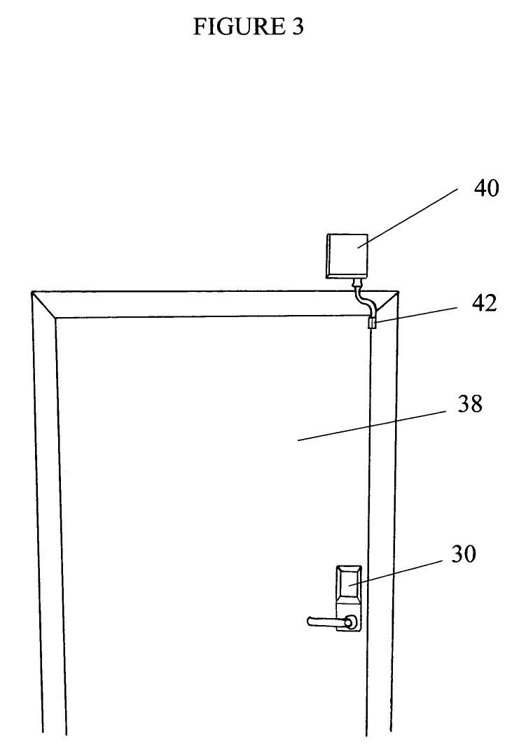

FIG. 3 is a perspective view from inside a room using the electronic mortise lockset mechanism 30. The mechanism is capable of transmitting an override command to a receiver module 40, shown mounted above the monitored door. The receiver module 40 has the ability to defeat the interlock mechanism 42.

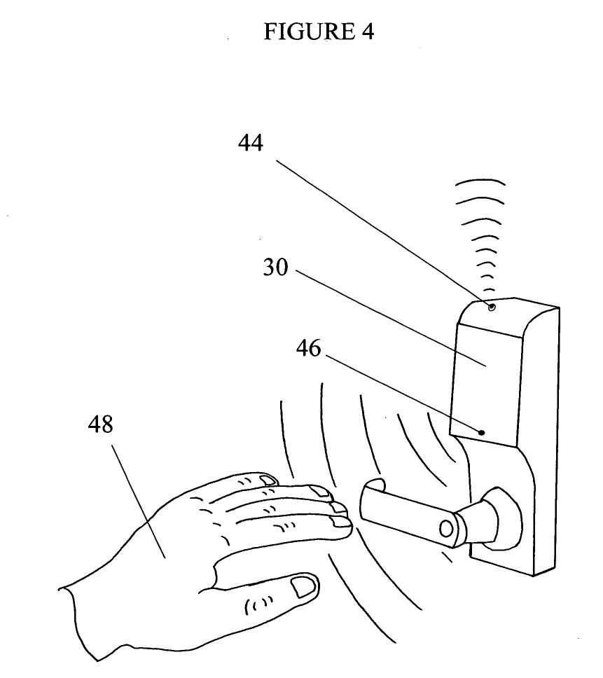

FIG. 4 is a perspective view of the electronic mortise lockset mechanism 30 with transmitter 44 and hand presence detector 46 functions. A hand presence detector 46 is used on the interior door handle to sense a occupant approaching to exit the room 48.

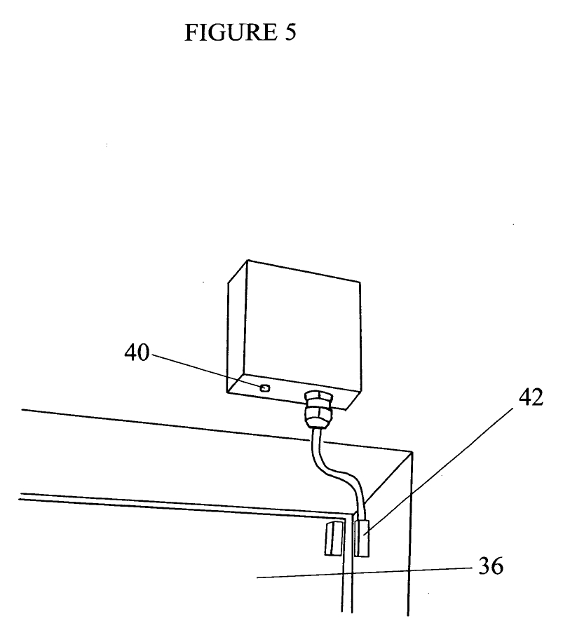

FIG. 5 is a perspective view of a door interlock receiver module 40. The module is shown mounted immediately above the interior door frame, but it may be located anywhere within the reception range of the mortise lockset transmitted signal. The interlock receiver module 40 contains the circuitry necessary to override the interlock mechanism 42.

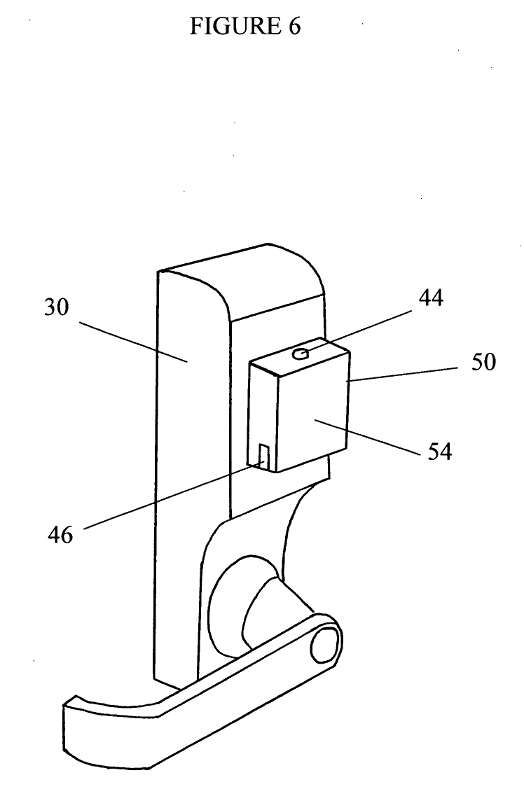

FIGS. 6 & 7—Alternate Embodiments

FIG. 6 is a perspective view of an alternate embodiment of the defeatable access control system with electronic mortise lockset mechanism 30 shown on the interior of a protected area door. Since the economics of scale presently limits the full production of an electronic mortise lockset mechanism 30 with all necessary features, a commercially available mechanism is shown with a conversion module mounted on the interior side. The electronic mortise lockset conversion module 50 contains a hand presence detector 46, electronics to monitor access credentials 54, and transmitter 44 to communicate with a remote receiver module 40.

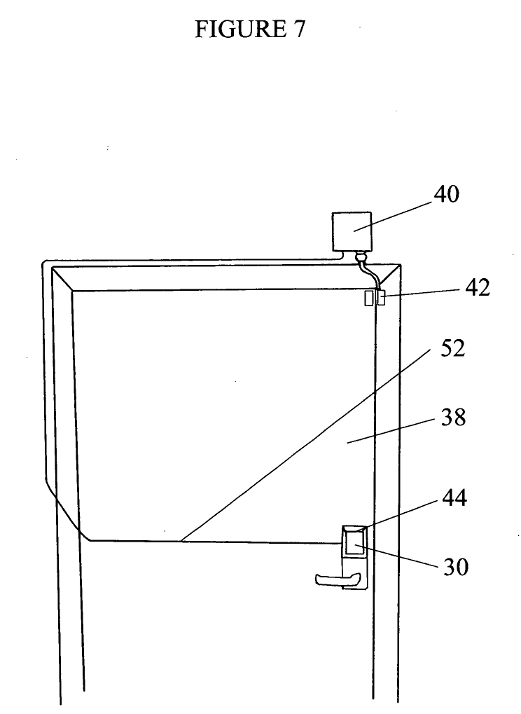

FIG. 7 is a perspective view of an alternate embodiment of the defeatable access control system with electronic mortise lockset mechanism 30. A hard wired connection 52 between the transmitter 44 and receiver module 40 can be seen when looking at the interior view of secure area door 38. In such an embodiment, the system could bypass the interlock mechanism 42 without the need for free space transmission. This method would be considered preferable in areas of high security where the interception of communication would be a security concern.

From the description above, it becomes evident that a number of advantages exist when using the present inventions system and method of defeatable access control in place of the prior art method utilizing a magnetic lock. These are:

(a) The electronic lockset permits entry to the interlocked area by persons presenting the proper electronic credentials and functions identically to a conventional mortise lockset for exit from an area. There is no longer a fear of being inadvertently locked within a space should a magnetic lock fail to release during an emergency.

(b) The complications associated with the precise mechanical installation and alignment requirements of magnetic locks have been eliminated. The mechanical installation of the lock is as simple as any conventional lockset.

(c) The system wiring has been greatly simplified over that of a magnetic lock system. Several components that are required to make magnetic locks failsafe have been eliminated. (e.g. crash switches, fire alarm system connection, and magnetic lock controller)

(d) The overall security of the interlocked space has been enhanced. Unlike a magnetic lock, the electronic mortise lockset does not unlock the door during a power failure.

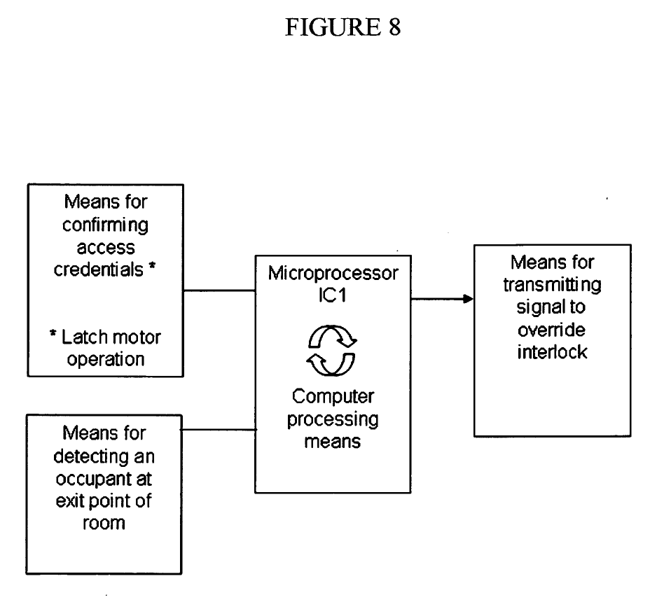

Detail of System Operation—FIGS. 8-13

The preferred embodiment of the defeatable room access control system accomplishes six major operational functions:

(a) The system has the intelligence to sense lock operation by a user that has entered proper credentials.

(b) The system is able to sense a user about to exit the protected area.

(c) The system will quickly engage an override of the door position sensor when event (a) or (b) above has occurred. This override is faster than the human time response of turning the door handle and opening the interlocked door.

(d) The system warns personnel that an override action has occurred.

(e) The system reliably cancels the override action when the door to the protected area is closed after a controlled access.

(f) The interlock system will reliably trip if a forced entry without proper credentials occurs.

Standard (unmodified) electronic mortise lockset operation is briefly discussed to provide an understanding of basic operation before detailing the modifications required for implementation in a defeatable access control system.

The standard electronic mortise lockset is battery powered and is designed for security and long battery life. The front handle of the lockset is normally not mechanically linked to the latch bolt, thus when the handle is turned it does not retract the bolt. When a user enters the proper credentials, a motor engages a mechanical connection between the outer handle and the latch bolt. This connection is normally electrically held for one or two seconds to permit entry through a door. The interior handle is always mechanically linked to the latch bolt, thus exit from a room is never dependent on electronic control.

When considering a modification of the standard electronic mortise lockset for our preferred embodiment design, we can consider the following:

(a) Since a latch motor activation only occurs when proper credentials are entered, monitoring this motor voltage signal will suffice for the purpose of verifying credentials.

(b) Since there is no electronic control necessary for operation of the interior latch handle, a hand proximity detector will be desired to sense an occupant approaching to exit from the area. Once a hand is detected, the system will defeat the interlock. An alternate embodiment of the system could be built that does not sense the interior handle, but instead relies on an area motion detector or a traditional push-to-exit button to signal the interlock defeat during exit.

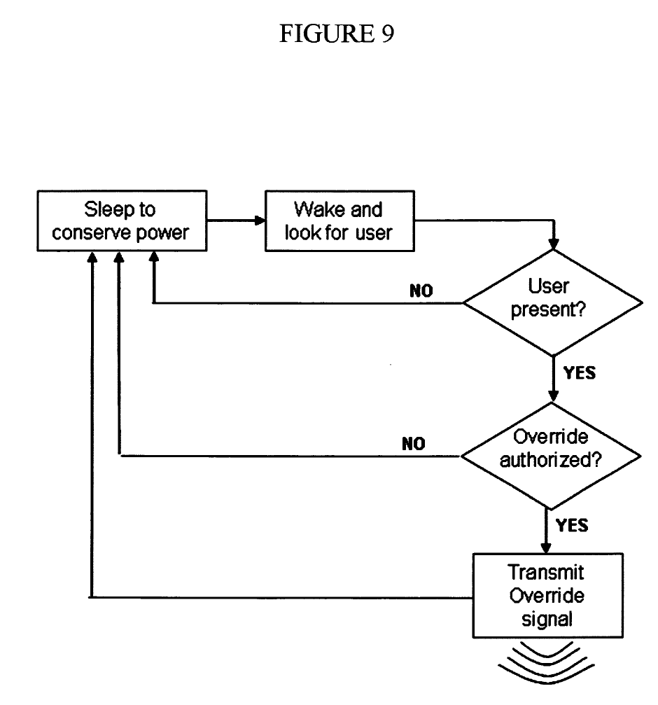

FIG. 8 provides a block diagram of an interlock control module added to the electronic mortise lockset mechanism 30. Microprocessor IC1 runs a continuous control loop of the pseudo-code depicted in FIG. 9 at a rate of approximately ten iterations per second. This rate is chosen to provide a proper balance of sleep time vs. run time in order to conserve battery power. The run time rate will ensure that an override action can be implemented faster than the human time response of turning the door handle and opening the door. At each waking cycle the microprocessor checks for front handle and rear handle latch operation. If the microprocessor does not detect a user, it goes back to sleep mode to conserve battery power. If a user has activated the front handle or if a user is present at the rear handle, the microprocessor will signal the transmitter 44 to send an override message to the receiver module 40 for processing. FIG. 8 shows a means for confirming access credentials 32. The latch motor of the mortise lockset mechanism is monitored to achieve this means, but another embodiment may derive this signal directly from the latch microprocessor. FIG. 8 also shows a means for detecting an occupant at exit point of room. In the preferred embodiment, this function detects approach to the interior latch handle. This function may be accomplished in many ways including, but not limited to, infrared, ultra-sonic, or capacitive motion or distance sensing. The remaining block of FIG. 8 depicts a means for transmitting signal to override interlock. There are many ways of accomplishing this function including, but not limited to, infrared, rf, ultra-sonic, or hard wiring.

FIG. 9 describes the electronic mortise lockset transmitter 44 microcontroller pseudo-code. The code is written to ensure that a command to override the interlock will only be transmitted when a user with proper credentials has operated the front handle or when a user is exiting the room. The microcontroller executes the code in a linear sequence of sleep, wake, check for users, sleep if no users present, else transmit override command and return to sleep.

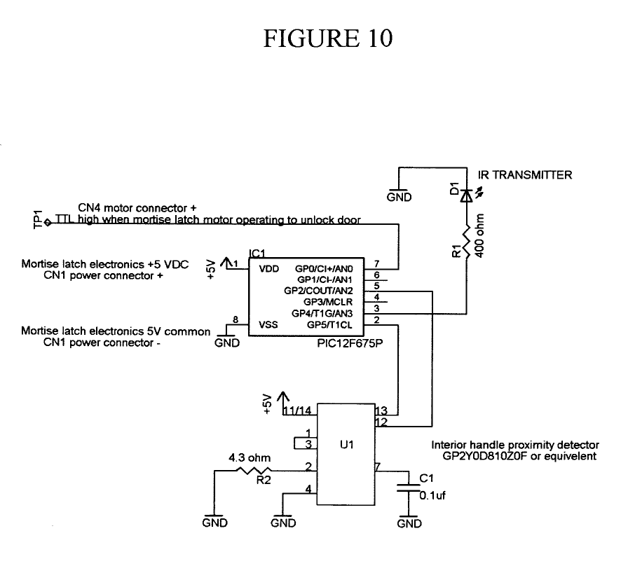

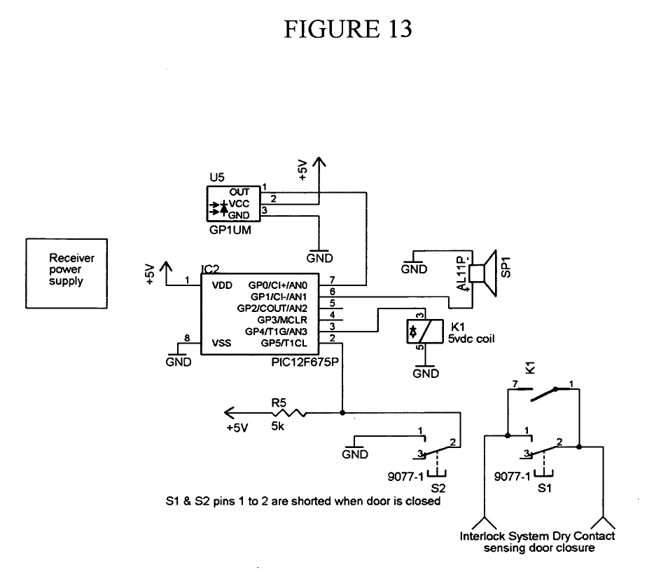

FIG. 10 depicts a preferred embodiment electronic mortise lockset transmitter 44 schematic. The microprocessor IC1 is type PIC12F675, manufactured by Microchip Technology Inc and distributed by DIGI-KEY Corp., Thief River Falls, Minn. Actual brand of microprocessor is not critical, but should be of a variety that has ultra-low power consumption in order to maximize battery life. Power to the microprocessor is taken from the electronic mortise lockset power supply. An infrared LED, D1 is type QED123, manufactured by Fairchild Optical Group and distributed by DIGI-KEY Corp., Thief River Falls, Minn. IC1 pin 3 pulses LED D1 via current limiting resistor R1 at a 38 kHz rate to send a pulse modulated “override” command to the receiver designated U5 shown in FIG. 13. This override command can be a simple set of hex encoded characters transmitted in a no parity, 8 data bit, 1 stop bit RS-232 transmission pattern. It is advantageous to send one set of characters designating an entry from the outside of the protected room, and another set of characters designating an exit from the room. In this manner the decoded signal can be used by the receiver microprocessor U2 of FIG. 13 to produce different enunciation tones based on entry or exit. TP1 of FIG. 10 is electrically connected to the mortise lockset motor signal. This TTL signal to microprocessor IC1 pin 7 indicates that an authorized user is entering the room. The component labeled U1 is an infrared proximity detector type GP2Y0D810Z0F, manufactured by SHARP electronics and distributed by DIGI-KEY Corp., Thief River Falls, Minn. There are several other types of proximity detector that will accomplish this function, but it is desirable to choose a detector with low current consumption. Pulsing the power to the detector and reading detector output only upon microprocessor wake-up is an effective means of lowering overall current consumption to maximize battery life. With this in mind, IC1 pin 5 is connected to U1 pin 12 to pulse power to the detector. U1 pin 13 returns a signal to IC1 pin 2 when an occupant is detected within approximately 10 cm of the detector. Components C1 and R2 are specified by the detector datasheet for proper operation of the detector. Physical connections and part interrelations depicted in FIG. 10 are common to those skilled in the art. Datasheets provided by manufacturers of each component describe in detail the attributes and limitations of each device. Operation of the system is thereby determined by proper programming of microprocessor IC1 to perform the actions described in the FIG. 8 block diagram and FIG. 9 pseudo-code.

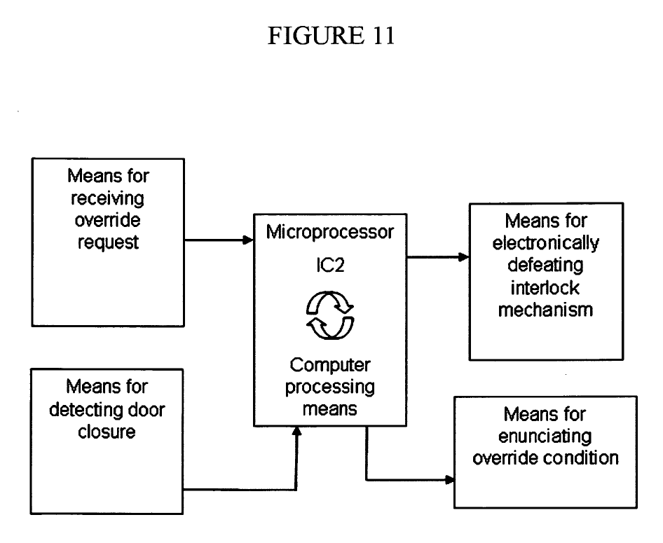

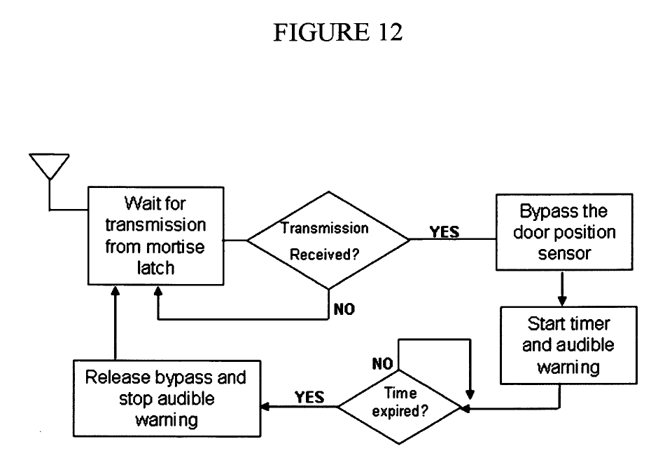

FIG. 11 depicts the receiver module 40 operating block diagram. The microprocessor IC2 runs the receiver module 40 pseudo-code depicted in FIG. 12. A means of receiving an override request is depicted by a block. This receiver must match the communication structure of the transmitter 44, and may be infrared, ultra-sonic, rf, hard wired, or other means. When a command to override is received, the microprocessor issues a command to the means for defeating interlock mechanism 42 and announces the override using a means for enunciating override condition. The override and enunciation are enabled for a time period determined by system programming or until the microprocessor senses that the door has been closed by the block labeled means for detecting door closure.

FIG. 12 describes the receiver module 40 microcontroller pseudo-code. This code is implemented in a manner that ensures that the interlock door position sensor will only be bypassed during an entry initiated by an authorized user or during an exit from the protected area. The microcontroller executes the code in a state machine determined program.

FIG. 13 Receiver module 40 electronic schematic describes the components required in a preferred embodiment receiver module 40. Microprocessor IC2 is type PIC12F675, manufactured by Microchip Technology Inc and distributed by DIGI-KEY Corp., Thief River Falls, Minn. Power is supplied to the circuitry from a battery or other 5VDC power source. An action begins when the microprocessor IC2 receives an override command from the electronic mortise lockset mechanism 30 transmitter 44 via receiver U5. Receiver U5 is designed to provide an output only when it receives an infrared signal modulated at 38 kHz. Recall that the transmitter 44 D1 of FIG. 10 was modulated at this same frequency. This process permits reliable infrared data communication over a distance of several meters without interference from room light. Receiver U5 is type GP1UM261XK0F, manufactured by SHARP electronics and distributed by DIGI-KEY Corp., Thief River Falls, Minn. Schematic component S1 is a typical interlock mechanism 42. Terminals 1 and 2 of this sensor are shorted when the door is closed and will open if the door is opened. When this circuit is broken, all systems attached to the interlock will be shut down. Upon decoding an input arriving on IC2 pin 7 from receiver U5, microprocessor IC2 will initiate an override of the interlock switch S1 by energizing relay coil K1. When relay K1 is energized, the K1 relay contacts short out switch S1 and prevent a trip of the interlock system as the door is opened for access. Switch S2 is a second interlock mechanism 42 placed in the circuit to permit direct door position sensing by microprocessor IC2. Using the signal from switch S2, arriving on microprocessor IC2 pin 2, the microprocessor can determine the appropriate time to remove the override condition after door closure. Speaker SP1 is provided to generate an audible signal announcing the override state when driven from microprocessor IC2 pin 6. Physical connections and part interrelations depicted in FIG. 13 are common to those skilled in the art. Datasheets provided by manufacturers of each component describe in detail the attributes and limitations of each device.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A defeatable room access control system comprising:
an electronic mortise lockset mechanism for mounting on a door to a protected room; said electronic mortise lockset electronically controlling entry to said room; a means for confirming access credentials accessible from outside said room; an interlock mechanism for verifying the closure status of said door; a means for electronically defeating said interlock mechanism; a means for detecting an occupant at exit point of said room; a computer processing means capable of monitoring and controlling all process functions; whereby said computer will exclusively activate a defeat of said interlock mechanism during credential initiated entry to and during all exits from said room.

2. A defeatable room access control system according to claim 1 wherein said means for confirming access credentials is physically attached to said electronic mortise lockset mechanism.

3. A defeatable room access control system according to claim 1 wherein said means for confirming access credentials is selected from the group comprising: keypad entry, biometric entry, smart card entry, magnetic stripe card entry.

4. A defeatable room access control system according to claim 1 wherein said means for detecting an occupant at exit point is selected from the group comprising: pushbutton switches, motion detectors, capacitive proximity detectors, infrared distance detectors.

5. A defeatable room access control system according to claim 1 wherein said means for detecting an occupant at exit point is physically attached to said electronic mortise lockset mechanism.

6. A defeatable room access control system according to claim 1 wherein said computer processing means is comprised of more than one microprocessor sharing said timing and control functions, one of said microprocessors being physically attached to said electronic mortise lockset mechanism.

7. A defeatable room access control system according to claim 6 wherein said microprocessors communicate by wireless data link.

8. A method of assembling a defeatable room access control system by providing access control apparatus comprising:
an electronic mortise lockset mechanism for mounting on a door to a protected room; said electronic mortise lockset electronically controlling entry to said room; a means for confirming access credentials accessible from outside said room; an interlock mechanism for verifying the closure status of said door; a means for electronically defeating said interlock mechanism; a means for detecting an occupant at exit point of said room; a computer processing means capable of monitoring and controlling all process functions; whereby said computer will exclusively activate a defeat of said interlock mechanism during credential initiated entry to and during all exits from said room.
